(19) United States
(12) Patent Application Publication
(10) Pub. No.: US 2014/0279099 A1
(43) Pub. Date: Sep. 18, 2014

(54) SYSTEM, PAYMENT AGENT AND COMPUTER READABLE STORAGE MEDIUM FOR FACILITATING CONTACTLESS MOBILE PAYMENT TRANSACTIONS

(71) Applicant: Spectrum Message Services Pty Ltd, Brookvale (AU)

(72) Inventors: Gerardus Johannes Franciscus Vos, Avalon Beach (AU); Miklos Braun, Manly (AU)

(73) Assignee: Spectrum Message Services Pty Ltd, Brookvale (AU)

(21) Appl. No.: 14/291,158

(22) Filed: May 30, 2014

Related U.S. Application Data
(63) Continuation of application No. PCT/AU2012/001436, filed on Nov. 21, 2012.

(30) Foreign Application Priority Data
Nov. 30, 2011 (AU) 2011904979

(51) Int. Cl. G06Q 20/32; G06Q 20/20

(52) U.S. Cl. CPC G06Q 20/322; G06Q 20/20
USPC 705/16

(57) ABSTRACT

A system for facilitating contactless mobile payment transactions comprises a payment network, an issuer switch operably coupled to the payment network, and a payment agent operably coupled to the issuer switch. In use, the issuer switch receives, via the payment network, a point of sale transaction request, the issuer switch sends a primary transaction request to the payment agent, the payment agent sends a virtual transaction request in accordance with the primary transaction request, the payment agent receives a virtual transaction reply, the payment agent sends a primary transaction reply to the issuer switch in accordance with the virtual transaction reply, and the issuer switch sends, via the payment network, a point of sale transaction reply in accordance with the primary transaction reply.

### CROSS-REFERENCE TO RELATED APPLICATIONS

This is a continuing application, under 35 U.S.C. §120, of copending international application No. PCT/AU2012/001436, filed Nov. 21, 2012, which designated the United States and was published in English; this application also claims the priority, under 35 U.S.C. §119, of Australian patent application No. 2011904979, filed Nov. 30, 2011; the prior applications are herewith incorporated by reference in their entirety.

### STATEMENT REGARDING FEDERALLY SPONSORED RESEARCH OR DEVELOPMENT

Not Applicable

### FIELD OF THE INVENTION

The present invention relates to financial transaction processing and, in particular, to a system, payment agent, and computer readable storage medium facilitating contactless mobile payment transactions.

The invention has been developed primarily for use in/with near field communication (NFC) chip bearing payment instruments and/or mobile devices and will be described hereinafter with reference to this application. However, it will be appreciated that the invention is not limited to this particular field of use.

### BACKGROUND OF THE INVENTION

In 2011, out of a population of 7 billion people in the world, there was over 5.3 billion mobile devices. The rapid take up of social media has caused a revolution of the take up of smart mobile devices. As companies now seek to target the mobile device as a new payment instrument, card issuers face competition as payment instrument suppliers by new entrants placing wallet functionality in mobile devices. It is foreseen that Near Field Communication (NFC) may play a major role in the acceptance and spread of mobile payments at the Point of Sale. NFC allows faster payments by enabling a cardholder to pay by tapping their card (or mobile device with the card) against the NFC reader at the Point of Sale (point of sale).

However, according to existing arrangements, if a mobile device is used. then the limitation is often that there is only one NFC chip in the mobile device or attached to the mobile device giving the user less choice when they pay than compared to a conventional wallet.

Currently there are two major obstacles to growth with NFC payments and mobile devices:
1. It will be quite some time before a large proportion of handsets have a second SIM to contain the NFC chip (at least 2-3 years); and
2. If only one NFC chip is present, then a user has only one payment instrument enabled, requiring the need to store multiple credentials in a single chip.

As such, a need exists for a system facilitating contactless mobile payment transactions that overcomes or substantially ameliorates at least some of the deficiencies of the prior art, or at least provides an alternative.

It is to be understood that, if any prior art information is referred to herein, such reference does not constitute an admission that the information forms part of the common general knowledge in the art, in Australia. or any other country.

Thus, a need exists to overcome the problems with the prior art systems, designs, and processes as discussed above.

### SUMMARY OF THE INVENTION

The invention provides a system, payment agent, and computer readable storage medium facilitating contactless mobile payment transactions that overcome the hereinafore-mentioned disadvantages of the heretofore-known devices and methods of this general type.

According to one aspect, there is disclosed a payment method and system allowing cardholders to interact with a mobile wallet in the Internet cloud via the browser on their mobile device, whilst a single NFC chip (in the mobile device, on a card, or attached to the mobile device via a sticker) is used as payment instrument at the point of sale. The mobile wallet server receives an authorization request with the default card number in the NFC chip, and substitutes this with a transaction with the chosen payment instrument back to the issuer host. This allows card issuers to provide their customers with multiple payment instruments in a wallet accessible via the combination of the mobile device and the single chip.

Advantageously, the secure element (the NFC chip) has a valid default payment identity, such that a variety of cloud-based payment identities can be accessed via the mobile channel, ensuring maximum flexibility that does not require regular updating of the secure element and is less sensitive to loss of the mobile device.

According to another aspect a system is provided that facilitates contactless mobile payment transactions, the system comprising a point of sale terminal; a payment network; and a payment agent; wherein: the point of sale terminal is adapted for sending a point of sale transaction request to the payment network; the payment network is adapted for sending a primary transaction request to the payment agent; the payment agent is adapted for sending a virtual transaction request in accordance with the primary transaction request; the payment agent is adapted for receiving a reply virtual transaction result; the payment agent is adapted for sending a reply primary transaction result to the payment network in accordance with the reply virtual transaction result; and the payment network is adapted for sending a point of sale reply to the point of sale terminal in accordance with the reply primary transaction result.

Advantageously, the system is adapted for facilitating contactless mobile payment transactions and, in particular, for providing a cloud-based wallet implemented by a payment agent. Furthermore, the system is compatible with existing payment transaction systems.

Preferably, the payment agent is adapted for receiving payment instructions.

Advantageously, the payment agent may be instructed by a user how to process payments from the mobile wallet.

Preferably, the payment agent is adapted for receiving payment instructions via a web interface.

Preferably, the payment agent is adapted for creating the virtual transaction request in accordance with the payment instructions.

Preferably, the payment instructions comprises payment instructions selected from the set of payment instructions comprising payment instrument and payment limit instructions.

Preferably, the payment instrument instructions comprise a selection of a primary account number linked to a payment instrument.

Preferably, the payment agent is adapted for comparing the primary transaction request against the payment limit instructions.

Advantageously, the user is able to make payment instructions (such as which credit or debit card to use for the processing of wallet payments, payment limits and the like) from a mobile device having a browser application, wherein the mobile phone is provided with the primary access number associated with the payment agent. In this manner, a user can control his or her financial transaction and also initiate financial transactions from the mobile device.

Preferably, the system further comprises a data-bearing device and wherein the data-bearing device comprises a primary account number linked to the payment agent and wherein the data bearing device is adapted for providing a primary account number to the point of sale terminal.

Preferably, the payment network is adapted for routing the primary transaction request in accordance with a Bank Identification Number (BIN) of the primary account number linked to the payment agent.

Advantageously, the primary account number linked to the payment agent may be used by existing payment network technology wherein the BIN of the primary account number is used by the payment network to route the primary transaction request to the payment agent for processing.

Preferably, the payment agent is adapted for creating the virtual transaction request by substituting the primary account number linked to the payment agent with the primary account number linked to the payment instrument.

Advantageously, the payment agent is adapted for processing the financial transaction with the user's chosen payment instrument.

Preferably, the data-bearing device comprises a near field communication chip adapted for storing the primary account number linked to the payment agent.

Preferably, the payment agent is further adapted for sending a receipt.

Preferably, the payment agent is further adapted for sending a receipt to a mobile device.

Preferably, the receipt is selected from the set of receipts comprising SMS and push notification receipts.

Advantageously, a user is able to be alerted of any payment transactions processed by the payment server, not only for receipt purposes but also for security purposes wherein the user can take steps in the event of an unauthorized transaction.

According to another aspect, there is provided a payment agent for facilitating contactless mobile payment transactions, the payment agent comprising a processor for processing digital data; a memory device for storing digital data including computer program code and being coupled to the processor via a bus; and a network interface for sending and receiving digital data and being coupled to the processor via a bus; wherein the processor is controlled by the computer program code to: receive, via the network interface, a primary transaction request from a payment network; send, via the network interface, a virtual transaction request in accordance with the primary transaction request; receive, via the network interface, a reply virtual transaction result; send, via the network interface, a reply primary transaction result to the payment network in accordance with the reply virtual transaction result.

Preferably, the processor is controlled by the computer program code to receive payment instructions via the network interface.

Preferably, the processor is controlled by the computer program code to receive payment instructions via a web interface via the network interface.

Preferably, the processor is controlled by the computer program code to create the virtual transaction request in accordance with the payment instructions.

Preferably, the payment instructions comprises payment instructions selected from the set of payment instructions comprising payment instrument and payment limit instructions.

Preferably, the payment instrument instructions comprise a selection of a primary account number linked to a payment instrument.

Preferably, the processor is controlled by the computer program code to compare the primary transaction request against the payment limit instructions.

Preferably, the primary transaction request comprises a primary account number linked to the payment agent and wherein the processor is controlled by the computer program code to create the virtual transaction request by substituting the primary account number linked to the payment agent with the primary account number linked to the payment instrument.

Preferably, the payment agent is adapted to decline a primary transaction request if no payment instructions have been received within a predetermined period prior to receiving the primary transaction request.

Preferably, the processor is controlled by the computer program code to send a receipt via the network interface.

Preferably, the processor is controlled by the computer program code to send a receipt to a mobile device via the network interface.

Preferably, the receipt is selected from the set of receipts comprising SMS and push notification receipts.

According to another aspect, there is provided a computer readable storage medium for facilitating contactless mobile payment transactions, the computer readable storage medium having computer program code instructions recorded thereon, the computer program code instructions being executable by a computer and comprising: instructions for receiving, via the network interface, a primary transaction request from a payment network; instructions for sending, via the network interface, a virtual transaction request; instructions for receiving, via the network interface, a reply virtual transaction result; instructions for sending, via the network interface, a reply primary transaction result to the payment network in accordance with the reply virtual transaction result.

Preferably, the computer readable storage medium further comprises instructions for receiving payment instructions via the network interface.

Preferably, the computer readable storage medium further comprises instructions for receiving payment instructions via a web interface via the network interface.

Preferably, the computer readable storage medium further comprises instructions for creating the virtual transaction request in accordance with the payment instructions.

Preferably, the payment instructions comprises payment instructions selected from the set of payment instructions comprising payment instrument and payment limit instructions.

Preferably, the payment instrument instructions comprise a selection of a primary account number linked to a payment instrument.

Preferably, the computer readable storage medium further comprises instructions for comparing the primary transaction request against the payment limit instructions.

Preferably, the primary transaction request comprises a primary account number linked to the payment agent and further comprises instructions for creating the virtual transaction request by substituting the primary account number linked to the computer readable storage medium with the primary account number linked to the payment instrument.

Preferably, the computer readable storage medium further comprises instructions for sending a receipt via the network interface.

Preferably, the computer readable storage medium further comprises instructions for sending a receipt to a mobile device via the network interface.

Preferably, the receipt is selected from the set of receipts comprising SMS and push notification receipts.

Other aspects of the invention are also disclosed.

Although the invention is illustrated and described herein as embodied in a system, payment agent, and computer readable storage medium facilitating contactless mobile payment transactions, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a block diagram of a payment agent computing device on which the various embodiments described herein may be implemented in accordance with an exemplary embodiment of the present invention;

FIG. 2 is a block diagram of a system for facilitating contactless mobile payment transactions in accordance with an exemplary embodiment of the present invention;

FIG. 3 is a graphical user interface for a mobile device in configuring payment instructions in accordance with an exemplary embodiment of the present invention;

FIG. 4 is a graphical user interface for a mobile device in configuring payment instructions in accordance with an exemplary embodiment of the present invention;

FIG. 5 is a graphical user interface for a mobile device in configuring payment instructions in accordance with an exemplary embodiment of the present invention; and

FIG. 6 is a graphical user interface for a mobile device in configuring payment instructions in accordance with an exemplary embodiment of the present invention.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

It will be appreciated that embodiments of the invention described herein may be comprised of one or more conventional processors and unique stored program instructions that control the one or more processors to implement, in conjunction with certain non-processor circuits and other elements, some, most, or all of the functions of the powered injector devices described herein. The non-processor circuits may include, but are not limited to, signal drivers, clock circuits, power source circuits, and user input and output elements. Alternatively, some or all functions could be implemented by a state machine that has no stored program instructions, or in one or more application specific integrated circuits (ASICs) or field-programmable gate arrays (FPGA), in which each function or some combinations of certain of the functions are implemented as custom logic. Of course, a combination of these approaches could also be used. Thus, methods and means for these functions have been described herein.

The terms “program,” “software,” “software application,” and the like as used herein, are defined as a sequence of instructions designed for execution on a computer system. A “program,” “software,” “application,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

Described now are exemplary embodiments of the present invention.

Payment Agent Computing Device

Referring now to the figures of the drawings in detail and first, particularly to FIG. 1, there is shown a first exemplary embodiment of a payment agent computing device 100 on which the various embodiments described herein may be implemented. The payment agent computing device 100 typically takes the form of a server, coupled to one or more computing devices via a network 180, such as a financial transaction processing network, as described in further detail below.

In particular, the steps of facilitating contactless mobile payment transactions may be implemented as computer program code instructions executable by the computing payment agent computing device 100. The computer program code instructions may be divided into one or more computer program code instruction libraries, such as dynamic link libraries (DLL), wherein each of the libraries performs one or more steps of the methods described. Additionally, a subset of the one or more of the libraries may perform graphical user interface tasks relating to the steps of the methods.

The payment agent computing device 100 comprises semiconductor memory 110 comprising volatile memory such as random access memory (RAM) or read only memory (ROM). The memory 100 may comprise either RAM or ROM or a combination of RAM and ROM.

The payment agent computing device 100 comprises a computer program code storage medium reader 130 for reading the computer program code instructions from computer program code storage media 120. The storage media 120 may be optical media such as CD-ROM disks, magnetic media such as floppy disks and tape cassettes or flash media such as USB memory sticks.

The payment agent computing device 100 further comprises I/O interface 140 for communicating with one or more peripheral devices. The I/O interface 140 may offer both serial and parallel interface connectivity. For example, the I/O interface 140 may comprise a Small Computer System Interface (SCSI), Universal Serial Bus (USB) or similar I/O interface for interfacing with the storage medium reader 130. The I/O interface 140 may also communicate with one or more human input devices (HID) 160 such as keyboards, pointing devices, joysticks and the like. The I/O interface 140 may also comprise a computer-to-computer interface, such as a Recommended Standard 232 (RS-232) interface, for interfacing the payment agent computing device 100 with one or more personal computer (PC) devices 190. The I/O interface 140 may also comprise an audio interface for communicate audio signals to one or more audio devices 1060, such as a speaker or a buzzer.

The payment agent computing device 100 also comprises a network interface 170 for communicating with one or more computer networks 180. The network 180 may be a wired network, such as a wired Ethernet network or a wireless network, such as a Bluetooth™ network or IEEE 802.11 network. The network 180 may be a local area network (LAN), such as a home or office computer network, or a wide area network (WAN), such as the Internet or private WAN.

The payment agent computing device 100 comprises an arithmetic logic unit or processor 1000 for performing the computer program code instructions. The processor 1000 may be a reduced instruction set computer (RISC) or complex instruction set computer (CISC) processor or the like. The payment agent computing device 100 further comprises a storage device 1030, such as a magnetic disk hard drive or a solid state disk drive.

Computer program code instructions may be loaded into the storage device 1030 from the storage media 120 using the storage medium reader 130 or from the network 180 using network interface 170. During the bootstrap phase, an operating system and one or more software applications are loaded from the storage device 1030 into the memory 110. During the fetch-decode-execute cycle, the processor 1000 fetches computer program code instructions from memory 110, decodes the instructions into machine code, executes the instructions and stores one or more intermediate results in memory 100.

In this manner, the instructions stored in the memory 110, when retrieved and executed by the processor 1000, may configure the computing payment agent computing device 100 as a special-purpose machine that may perform the functions described herein.

The payment agent computing device 100 may also comprise a video interface 1010 for conveying video signals to a display device 1020, such as a liquid crystal display (LCD), cathode-ray tube (CRT) or similar display device.

The payment agent computing device 100 also comprises a communication bus subsystem 150 for interconnecting the various devices described above. The bus subsystem 150 may offer parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like.

In an exemplar embodiment, the payment agent computing device 100 may also be provided with a web server application for receiving requests, such as Hypertext Transfer Protocol (HTTP) and File Transfer Protocol (FTP) requests, and serving hypertext web pages or files in response. The web server application may be, for example the Apache™ or the Microsoft™ IIS HTTP server. In this manner, the payment agent computing device 100 may manage payment instructions by interfacing with a browser application on a mobile device in the manner described in further detail below.

The payment agent computing device 100 may also be provided with a hypertext preprocessor for processing one or more web page templates and data from one or more databases to generate hypertext web pages. The hypertext preprocessor may, for example, be the PHP: Hypertext Preprocessor (PHP) or Microsoft Asp® hypertext preprocessor. The payment agent computing device 100 may also be provided with web page templates, such as one or more PHP or ASP files.

Upon receiving a request from the web server application, the hypertext preprocessor is operable to retrieve a web page template, from the web page templates, execute any dynamic content therein, including updating or loading information from the one or more databases, to compose a hypertext web page. The composed hypertext web page may comprise client side code, such as Javascript, for Document Object Model (DOM) manipulating, asynchronous HTTP requests and the like.

System for Facilitating Contactless Mobile Payment Transactions

FIG. 2 shows a system 200 for facilitating contactless mobile payment transactions. The system 200 comprises the payment agent computing device 100, a mobile device 205, a point of sale (POS) terminal 210, a payment network 235, and an issuer host 220. The payment network 235 typically comprises an acquirer switch 230 and an issuer switch 215. However, depending on the financial transaction, such as where the issuer and the acquirer are the same provider, the acquirer switch 230 may perform the functions of the issuer switch 215 described herein.

It should be noted that the mobile device 205, the POS terminal 210, the acquirer switch 230, the issuer switch 215 and the issuer host 220 form part of existing payment processing infrastructure and require no substantial modification for the facilitation of contactless mobile payment transactions as described herein. However, as will be described in further detail below, the issuer switch 215 may require programming to recognize primary account numbers associated with the payment agent computing device 100 for the purposes of forwarding financial transactions to the payment agent computing device 100.

Facilitating Contactless Mobile Payment Transactions

There are two main issues that need to be solved to provide fast and flexible payments at the POS terminal 210. Firstly, there needs to be a trusted payment instrument based on EMV (Europay™, MasterCard™ and VISA™) to quickly identify the user's payment identity to the system. Secondly, the user needs to be able to interact with the system 200 in the manner described below to configure payment instructions prior to a payment transaction taking place.

The solution to the first issue lies in the application of a single near field communication (NFC) chip 225 in the mobile device 205, an NFC sticker on the back of the mobile device 205 or a traditional single NFC enabled card. This NFC chip will have a payment identity linked with the party issuing this chip using their Bank Identification Number (BIN) range (the first 6-10 digits of the Primary Account Number (PAN) identifying the card).

There is disclosed the interaction of the cardholder with the payment agent computing device 100 prior to the transaction and the two step authorization process allowing the substitution of the default payment instrument with the chosen payment instrument. The following steps occur.
Step 1: Prior to the transaction, the cardholder will specify certain payment instructions, described with further reference to FIGS. 3 to 6. Specifically, using a launching button or browser bookmark on their mobile device 205, the user is able to log in to their wallet on the payment agent computing device 100, as shown in FIG. 3. It is noted that, while the embodiments shown in FIGS. 3 to 6 are web browser based, in other embodiments such functionality may be implemented by other measures, such as by application software and the like. As shown in FIGS. 4 and 5, the user can select with which payment instruments to pay (debit, credit, gift, loyalty, coupons, etc.) and can optionally set a limit for the transaction for increased security.

Typically, the payment agent computing device 100 comprises details of various payment instruments of the user. In this manner, for security purposes, the payment agent computing device 100 may be adapted to send obscured data, such as only the last four digits of each primary account number for each payment instrument so as to allow the user to recognize the applicable payment instrument for selection without compromising security by sending primary account numbers across a network.

The payment agent computing device 100 tells the user that the wallet selection was done and that the user is ready for payment.
Step 2: At the POS terminal 210, the user taps the NFC equipped mobile device 205 (or the NFC card itself) against a NFC reader such that the NFC reader is able to read the identity of the NFC chip. The chip is loaded with a primary account number (PAN) linked to the payment agent computing device 100 configured by the institution that issued the NFC card. The POS terminal 210 sends a normal financial transaction request message to the issuer switch 215 via the merchant's acquirer switch 230. Annex A below shows an example of a typical 0200 financial transaction request message that is commonly used and follows the international ISO 8583 Financial Transaction messaging standard. The system does not change the protocol and equally applies when other financial messaging standards or variations (such as AS2805) are used.
Step 3: During the transaction authorization process the issuer switch 215 runs a secondary authorization when it recognizes from the BIN that a wallet NFC chip was used, and communicates with the payment agent computing device 100 to conduct a virtual POS transaction with the chosen payment instrument. The steps described in the following text occur.
   a: The issuer switch 215 sends the original 0200 transaction request message to the payment agent computing device 100.
   b: This payment agent computing device 100 checks if it has received a wallet interaction from the wallet linked with that NFC card. If the answer is yes, the payment agent computing device 100 first checks that the transaction is below the limit. If this is not the case, the payment agent computing device 100 declines the transaction and it is declined back to the POS terminal 210. Conversely, if the transaction is below the limit, then the payment agent computing device 100 creates a Virtual Point of Sale (VPOS) secondary authorization request for the same amount with the chosen card number from the wallet.
   c: The issuer host 220 processes this secondary authorization request using its normal authorization process. The issuer host 220 responds with an 0210 authorization response message (see Annex A below).
      i: If the secondary authorization request is declined, then the payment agent computing device 100 wallet formulates a decline response to the 0200 primary transaction request in Step 3(a). The issuer switch 215 then sends a decline response via the acquirer switch to the POS terminal 210.
      ii: If the secondary authorization request is approved, then the payment agent computing device 100 wallet formulates an approved response to the 0200 primary request. The issuer host then sends back a normal approved response via the acquirer to the request from the POS terminal 210.
Step 4: The payment agent computing device 100 can optionally send a transaction confirmation receipt via SMS or data channel to the mobile device 205.
Step 5: The issuer settles the transaction at the end of the day with the acquirer as per normal.
Step 6: The issuer settles the same transactions with the virtual POS but takes the funds from the chosen payment instruments to internally settle the transactions that were settled with the acquirer in step 5.

In the above manner, the acquirer does not have to support the wallet nor does the POS terminal 210 need modification and the normal NFC payment process applies. The card represented by the NFC chip is a valid branded card (e.g., MasterCard) having negative authorization and can be used at any domestic or international POS terminal 210 regardless of the acquirer.

Message Flow

Referring to FIG. 2, there will now be described in further detail the message flow between the system 200 components, in which the following steps occur.
Step 1: The customer recognizes that the store accepts NFC payments, logs into their mobile wallet (using the mobile device 205 or other computing device coupled to the payment agent computing device 100), and selects the desired payment instrument (e.g., Mastercard having cardholder name Jon Smith and primary account number 54 4298 001 076 911 and expiring on 11/2014) and optionally sets a transaction limit (e.g., $100).
Step 2: The customer finalizes his or her purchase, checks out at the POS terminal 210, and taps the NFC reader with the mobile device 205 or the actual NFC chip. The NFC chip communicates the NFC card information (PAN (linked to the payment agent), expiry date, CVV, chip data, etc.).
Step 3: The POS terminal 210 creates a normal 0200 primary POS transaction request using the NFC data.
Step 4: The issuer switch recognizes that the PAN is linked to the payment agent and sends the primary transaction request to payment agent computing device 100.
Step 5: The payment agent computing device 100 initiates a secondary virtual POS transaction using the primary transaction request but substitutes the PAN linked with the payment agent computing device 100 with the PAN linked to the desired payment instrument, as configured by the user in step 1 (and other data relevant to this payment instrument). Note that in one embodiment, the payment agent computing device 100 is adapted to decline a primary transaction request if no payment instructions have been received within a predetermined period prior to receiving the primary transaction request.
Step 6: The issuer switch 215 obtains normal authorization from the issuer host 220 (sometimes the switch 215 itself performs the stand in authorization).
Step 7: The issuer host 220 sends the authorization response to the secondary transaction.
Step 8: The issuer switch 215 communicates the secondary VPOS transaction result back to payment agent computing device 100 (0210). If used, the payment agent computing device 100 can update any loyalty or gift card data associated with the transaction.
Step 9: The payment agent computing device 100 responds to primary transaction request (Step 4) based on the VPOS result.
Step 10: The issuer switch 215 creates response to the POS transaction request based on the primary transaction response of Step 9 and sends the response back to the POS terminal 210.
Step 11. The payment agent computing device 100 sends an electronic receipt for the transaction as either a push notification to a wallet application or as an SMS message to the mobile device 205.

The interaction with the payment agent computing device 100 is done at issuer level which gives maximum flexibility for payment instruments and allows the choice of payment instruments under the user's control. The system 200 can offer a choice of loyalty, gift, coupon, and debit and credit for payment. The system 200 also can cooperate with retailers to extend the offering and what can be provided in the wallet.

### INTERPRETATION OF TERMS AND USAGE OF PHRASES

“In accordance with”

As described herein, ‘in accordance with’ may also mean ‘as a function of’ and is not necessarily limited to the integers specified in relation thereto.

Composite Items

As described herein, ‘a computer implemented method’ should not necessarily be inferred as being performed by a single computing device such that the steps of the method may be performed by more than one cooperating computing devices. Similarly, objects as used herein such as ‘web server’, ‘server’, ‘client computing device’, ‘computer readable medium’ and the like should not necessarily be construed as being a single object, and may be implemented as a two or more objects in cooperation, such as, for example, a web server being construed as two or more web servers in a server farm cooperating to achieve a desired goal or a computer readable medium being distributed in a composite manner, such as program code being provided on a compact disk activatable by a license key downloadable from a computer network.

Wireless:

The invention may be embodied using devices conforming to other network standards and for other applications, including, for example other WLAN standards and other wireless standards. Applications that can be accommodated include IEEE 802.11 wireless LANs and links, and wireless Ethernet. In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

Processes:

Unless specifically stated otherwise, as apparent from the discussions herein, it is appreciated that, throughout the specification, discussions utilizing terms such as “processing”, “computing”, “calculating”, “determining”, “analyzing” or the like, refer to the action and/or processes of a computer or computing system, or similar electronic computing device, that manipulate and/or transform data represented as physical, such as electronic, quantities into other data similarly represented as physical quantities.

“Processor”

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors. The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

“Computer-Readable Medium”

Furthermore, a computer-readable carrier medium may form, or be included in a computer program product. A computer program product can be stored on a computer usable carrier medium, the computer program product comprising a computer readable program means for causing a processor to perform a method as described herein.

Networked or Multiple Processors:

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine. It is noted that, while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Additional Embodiments:

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

“Carrier Medium”

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

Implementation:

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Measures for Carrying out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

“Connected”

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still cooperate or interact with each other.

“Embodiment”

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments. Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

Terminology

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

“Comprising” and “Including”

In the claims which follow and in the preceding description of the invention, except where the context requires otherwise due to express language or necessary implication, the word “comprise” or variations such as “comprises” or “comprising” are used in an inclusive sense, i.e., to specify the presence of the stated features but not to preclude the presence or addition of further features in various embodiments of the invention. Any one of the terms: including or which includes or that includes as used herein is also an open term that also means including at least the elements/features that follow the term, but not excluding others. Thus, including is synonymous with and means comprising.

### SCOPE OF INVENTION

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention. Although the invention has been described with reference to specific examples, it will be appreciated by those skilled in the art that the invention may be embodied in many other forms.

### INDUSTRIAL APPLICABILITY

It is apparent from the above, that the arrangements described are applicable to the financial transaction processing industry.

The phrase “at least one of A and B” is used herein and/or in the following claims, where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

Annex A Standard Payment Messages:

### 0200 Authorization Request Message

Messages include a message type header (0200 in this case), one or more bitmaps (64 bits long) that indicate which fields are present, and the actual fields. If a bitmap position is set to 1, then the corresponding field is present. If a bitmap position is set to 0, then the field is not present. The fields below are the typical fields that can be present in an authorization request message:

| Field | Description |
|---|---|
| 2 | Primary account number (PAN) |
| 3 | Processing code |
| 4 | Amount, transaction |
| 5 | Amount, settlement |
| 7 | Transmission date and time |
| 9 | Conversion rate, settlement |
| 11 | Systems trace audit number |
| 12 | Time, local transaction |
| 13 | Date, local transaction |
| 14 | Date, expiration |
| 15 | Date, settlement |
| 16 | Date conversion |
| 18 | Merchant's type |
| 22 | point of sale entry mode |
| 23 | Card sequence number |
| 25 | point of sale condition code |
| 26 | point of sale PIN capture code |
| 27 | Authorization id response length |
| 28 | Amount, transaction fee |
| 29 | Amount, settlement fee |
| 30 | Amount, transaction processing fee |
| 31 | Amount, settle processing fee |
| 32 | Acquiring institution id code |
| 33 | Forwarding institution id code |
| 35 | Track 2 data |
| 37 | Retrieval reference number |
| 40 | Service restriction code |
| 41 | Card acceptor terminal id |
| 42 | Card acceptor id code |
| 43 | Card acceptor name/location |
| 45 | Track 1 data |
| 49 | Currency code, transaction |
| 50 | Currency code, settlement |
| 52 | PIN Data |
| 53 | Security related control information |
| 54 | Additional amounts |
| 56 | Message reason code |
| 58 | Authorizing agent id code |
| 59 | Echo data |
| 67 | Extended payment code |
| 90 | Original data elements |
| 95 | Replacement amounts |
| 98 | Payee |
| 100 | Receiving institution id code |
| 102 | Account identification 1 |
| 103 | Account identification 2 |
| 123 | point of sale data code |
| 127.1 | Bitmap |
| 127.4 | point of sale data |
| 127.5 | Service station data |
| 127.9 | Additional node data |
| 127.12 | Terminal owner |
| 127.13 | point of sale geographic data |
| 127.14 | Sponsor bank |
| 127.19 | Bank Details |
| 127.20 | Originator/Authorizer date |
| | settlement |
| 127.23 | Payee name and address |
| 127.24 | Payer account |
| 127.25 | ICC data |
| 127.27 | Card verification result |
| 128 | MAC Extended |

Most of these fields are replicated in the secondary transaction request. Changes are made to the PAN, the track 2 data (if applicable) and the card acceptor fields (to indicate virtual point of sale)

### 0210 Authorization Response Message

Many of the fields above are echoed so that the receiving party sees to which request it related. The main field added is field 39, which provides the authorization response, 00 is approved. The list below shows the typical fields:

| Field | Description |
|---|---|
| 2 | Primary account number |
| 3 | Processing code |
| 4 | Amount, transaction |
| 5 | Amount, settlement |
| 7 | Transmission date and time |
| 9 | Conversion rate, settlement |
| 11 | Systems trace audit number |
| 12 | Time, local transaction |
| 13 | Date, local transaction |
| 14 | Date, expiration |
| 15 | Date, settlement |
| 16 | Date conversion |
| 18 | Merchant's type |
| 22 | point of sale entry mode |
| 23 | Card sequence number |
| 25 | point of sale condition code |
| 28 | Amount, transaction fee |
| 29 | Amount, settlement fee |
| 30 | Amount, transaction processing fee |
| 31 | Amount, settle processing fee |
| 32 | Acquiring institution id code |
| 33 | Forwarding institution id code |
| 35 | Track 2 data |
| 37 | Retrieval reference number |
| 38 | Authorization id response |
| 39 | Response code |
| 40 | Service restriction code |
| 41 | Card acceptor terminal id |
| 42 | Card acceptor id code |
| 43 | Card acceptor name/location |
| 44 | Additional response data |
| 45 | Track 1 data |
| 49 | Currency code, transaction |
| 50 | Currency code, settlement |
| 54 | Additional amounts |
| 56 | Message reason code |
| 58 | Authorizing agent id code |
| 59 | Echo data |
| 67 | Extended payment code |
| 90 | Original data elements |
| 95 | Replacement amounts |
| 98 | Payee |
| 100 | Receiving institution id code |
| 102 | Account identification 1 |
| 103 | Account identification 2 |
| 123 | point of sale data code |
| 127.1 | Bitmap |
| 127.3 | Routing information |
| 127.4 | point of sale data |
| 127.5 | Service station data |
| 127.6 | Authorization profile |
| 127.9 | Additional node data |
| 127.12 | Terminal owner |
| 127.13 | point of sale geographic data |
| 127.14 | Sponsor bank |
| 127.19 | Bank Details |
| 127.20 | Originator/Authorizer date |
| | settlement |
| 127.23 | Payee name and address |
| 127.24 | Payer account |
| 127.25 | ICC data |
| 127.27 | Card verification result |
| 128 | MAC Extended |

What is claimed is:

1. A system for facilitating contactless mobile payment transactions, the system comprising:
a payment network;
an issuer switch operably coupled to the payment network; and
a payment agent operably coupled to the issuer switch, wherein, in use:
the issuer switch receives, via the payment network, a point of sale transaction request;
the issuer switch sends a primary transaction request to the payment agent;
the payment agent sends a virtual transaction request in accordance with the primary transaction request;
the payment agent receives a virtual transaction reply;
the payment agent sends a primary transaction reply to the issuer switch in accordance with the virtual transaction reply; and
the issuer switch sends, via the payment network, a point of sale transaction reply in accordance with the primary transaction reply.

2. The system according to claim 1, wherein the payment agent receives payment instructions.

3. The system according to claim 2, wherein the payment agent creates the virtual transaction request in accordance with the payment instructions.

4. The system according to claim 2, wherein the payment instructions are selected from at least one of payment instrument instructions and payment limit instructions.

5. The system according to claim 2, wherein:
the payment instructions comprise payment instrument instructions; and
the payment instrument instructions comprise a selection of a primary account number linked to a payment instrument.

6. The system according to claim 4, wherein:
the payment instructions comprise payment limit instructions; and
the payment agent compares the primary transaction request against the payment limit instructions.

7. The system according to claim 5, further comprising:
a point of sale terminal; and
a data bearing device comprising a primary account number linked to the payment agent, the data bearing device providing the primary account number to the point of sale terminal.

8. The system according to claim 7, wherein the issuer switch routes the primary transaction request in accordance with a bank identification number of the primary account number linked to the payment agent.

9. The system according to claim 7, wherein the payment agent creates the virtual transaction request by substituting the primary account number linked to the payment agent with the primary account number linked to the payment instrument.

10. The system according to claim 7, wherein the data bearing device comprises a near field communication chip storing the primary account number linked to the payment agent.

11. A payment agent for facilitating contactless mobile payment transactions, the payment agent comprising:
a digital data processor for processing digital data;
a memory device operably coupled to the processor and storing the digital data, the digital data including computer program code; and
a network interface operably coupled to the processor and sending and receiving the digital data across a network, wherein, in use, the processor is controlled by the computer program code to:
receive, via the network interface, a primary transaction request from an issuer switch;
send, via the network interface, a virtual transaction request in accordance with the primary transaction request;
receive, via the network interface, a virtual transaction reply; and
send, via the network interface, a primary transaction reply to the issuer switch in accordance with the virtual transaction reply.

12. The payment agent according to claim 11, wherein the processor is controlled by the computer program code to receive payment instructions via the network interface.

13. The payment agent according to claim 12, wherein the processor is controlled by the computer program code to create the virtual transaction request in accordance with the payment instructions.

14. The payment agent according to claim 12, wherein the payment instructions are selected from at least one of payment instrument instructions and payment limit instructions.

15. The payment agent according to claim 12, wherein:
the payment instructions comprise payment instrument instructions; and
the payment instrument instructions comprise a selection of a primary account number linked to a payment instrument.

16. The payment agent according to claim 14, wherein:
the payment instructions comprise payment limit instructions; and
the processor is controlled by the computer program code to compare the primary transaction request against the payment limit instructions.

17. The payment agent according to claim 15, wherein:
the primary transaction request comprises a primary account number linked to the payment agent; and
the processor is controlled by the computer program code to create the virtual transaction request by substituting the primary account number linked to the payment agent with the primary account number linked to the payment instrument.

18. The payment agent according to claim 12, wherein the payment agent declines a primary transaction request if no payment instructions have been received within a predetermined period prior to receiving the primary transaction request.
